(19) United States
(12) Patent Application Publication
(10) Pub. No.: US 2023/0288721 A1
(43) Pub. Date: Sep. 14, 2023

(54) HYPERCHROMATIC IMAGING SYSTEM WITH ANGULAR RESOLUTION

(71) Applicant: Mirage Hyperchromatica GmbH, Berlin (DE)

(72) Inventors: Nikolay Ledentsov, Berlin (DE); Vitaly Shchukin, Berlin (DE)

(21) Appl. No.: 18/102,899

(22) Filed: Jan. 30, 2023

Related U.S. Application Data
(60) Provisional application No. 63/304,795, filed on Jan. 31, 2022.

(51) Int. Cl. G02B 30/52

(52) U.S. Cl. CPC G02B 30/52

(57) ABSTRACT

A hyperchromatic three-dimensional (3D) imaging system creates multiple planar (2D) images located at different planes which are perceived by the observer's eyes as a 3D image, whereas a new functionality is added. Brightness of the display images is increased by applying narrow diffusion angles for the light scattered by the display. Narrow diffusion angle of the light also allows displays generating images such that each 2D image depends on the angle of observation, and a plurality of 2D images is perceived by the observer's eyes as a 3D image dependent on the angle of observation in a certain interval of the angles of observation. Angular spatial light modulator is employed as a display to generate beams directed in several predefined directions, beams being separately encoded for each direction. Scanning of an angle-maintaining diffuser screen by laser impinging onto the diffuser at different angles can be applied to ensure angle-resolved multi-view functionality.

### REFERENCE TO RELATED APPLICATIONS

This application claims an invention which was disclosed in Provisional Application No. 63/304,795, filed Jan. 31, 2022, entitled “HYPERCHROMATIC IMAGING SYSTEM WITH ANGULAR RESOLUTION”. The benefit under 35 USC § 119(e) of the United States provisional application is hereby claimed, and the aforementioned application is hereby incorporated herein by reference.

### FIELD OF THE INVENTION

The invention pertains to the field of optoelectronic devices. More particularly, the invention pertains to three-dimensional (3D) displays.

### DESCRIPTION OF RELATED ART

There is a strong need in generation of 3D images for multiple applications in sensing, displays, optical wireless and other fields. Multiple approaches have been proposed for generation of 3D images. In one class of applications 3D images may be generated by focus adjustment. First, two dimensional (2D) images are generated in a single plane of the display device, for example digital light processing (DLP) display, liquid crystal on silicon (LCoS) display, organic light-emitting diode (OLED) display, micro-LED display or scanning laser display and then the images are distributed through an optical system over a certain 3D volume as real or virtual images. Positioning of the 2D images are synchronized with the related display images. One of the approaches is based on using of passive hyperchromatic optics where the images are generated by light having different wavelengths. For example, images in the red spectral range at different wavelengths can generate a 3D multiplane red image. 3D images in green and blue can be generated in a similar way, and the resulting 3D full-color image can be formed by combining the three images.

A concept of applying passive hyperchromatic optics for generation of colored 3D images was disclosed in the U.S. Pat. No. 9,936,193, entitled “DEVICE FOR GENERATION OF COLORED VIRTUAL THREE-DIMENSIONAL IMAGES”, filed May 9, 2016, issued Apr. 3, 2018, by one of the inventors of the present invention, Ledentsov. A practical laser system based thereupon was disclosed in the U.S. Pat. No. 10,205,935, entitled “LASER SYSTEM FOR GENERATION OF COLORED THREE-DIMENSIONAL IMAGES”, filed Aug. 1, 2017, issued Feb. 12, 2019, by two of the inventors of the present invention, Ledentsov and Shchukin. Both patents are hereby incorporated herein in their entirety by reference.

A simplified scheme for hyperchromatic imaging is presented in FIG. 1. A 2D mini-display generates consequent images, which are illuminated by light having different wavelengths. Each image on the 2D display illuminated by particular wavelength is coded in such a way as it corresponds the cross section of the 3D object at a particular distance from the observer. Hyperchromatic optics provides different focal distances for light having different wavelengths. Known examples of the hyperchromatic optics include glass lenses, Fresnel zone plates, holographic lenses or reflectors, etc. Hyperchromatic optics used to separate the image planes in the eyes of the observer in such a way as he sees a complete three-dimensional image composed of planar sections. The larger the number of planes the better the volume resolution of the image. For example, once a semitransparent reflector is applied, virtual images are formed behind the reflecting mirror and are perceived by the observer eyes as such. Further, if the reflecting mirror is partially transparent the images can be superimposed to real objects. For example, warning sign images can be positioned at dangerous objects on the road in case of head up displays in vehicles.

Opposite to stereoscopic imaging, where the images are separated for left and right eyes but are both placed at the same plane located at some distance from the observer, which causes vergence-accommodation conflict, and can't be aligned to objects placed at different distances, this shortcoming is lifted in case of hyperchromatic imaging. In the latter case there is no need in eye refocusing between the image plane and the real object. Thus eye-fatigue is avoided and reaction time is reduced.

A schematic representation of the resulting 3D image is shown in FIG. 2 (top panel). Observer looks in the direction of the 3D image. The observer sees planes, each coding a different section of the object which is being projected onto the particular imaging plane. If the number of planes is sufficient, the observer perceives all the planes as a uniform 3D image with certain resolution in depth.

The images, nevertheless, behave as real objects composed of planar segments located in the real space. Consequently, once the positioning of the observer changes and the angle of view changes, the images shift in respect to the observer. The images aimed at different planes can either overlap or be separated exposing empty space as it is illustrated in FIG. 2 (bottom panel).

Thus, there is a need to overcome this deficiency of hyperchromatic imaging systems by adding a new functionality. The image perceived by the observer's eyes should be adjusted to a modified 3D image of the same object but seen from a different prospective once the position of the observer is shifted.

Displays, which overcome deficiency of stereoscopic or volumetric multiplayer displays, where the viewing angle is either fixed (stereoscopic) or restricted, light field displays are introduced to generate images of three-dimensional object both in depth and in an angle space.

A well-known way of generating of 3D images is holography. Holography images ideally do not suffer from parallax effect, at least in a certain range of observation angles. However, real holographic displays are not yet possible due to limited resolution of the imaging elements, which must be of sub-micrometer dimensions to generate true holographic patterns. Nevertheless, imaging elements have reached the level where diffraction effects become significant and with certain phase and intensity manipulations of the 2D micro display patterns, realization of holographic patterns becomes possible. Using digital holography one can generate presently small holographic images, even at limited quality. Digital holography is realized applying Spatial light modulators (SLMs).

In general SLMs are broadly applied for intensity and phase encoding of transmitted or reflected light. SLMs are used for beam steering devices, holographic optical storage, and other applications beyond digital holography. Piston-type Digital Micro-Mirror Devices (DMD) are used, for example, for phase encoding of the reflected optical signal.

Application of SLMs in holographic displays is particularly important for augmented and virtual reality applications enabling advanced human-machine interaction systems. However, modem SLM displays aimed at digital holography, suffer from a small field of view, limited depth of the 3D image and insufficient resolution of the pixels to generate truly 3D high-resolution image. Furthermore, laser illumination with coherent light at well-defined wavelength is needed and causes speckle effects.

The present invention aims to improve hyperchromatic displays by allowing advanced performance in directionality, extension of the field of view and by adding Multiview functionality.

### SUMMARY OF THE INVENTION

A hyperchromatic three-dimensional (3D) imaging system creates multiple planar (2D) images located at different planes which are perceived by the observer's eyes as a 3D image, whereas a new functionality is added. Brightness of the display images is increased by applying narrow diffusion angles for the light scattered by the display. Narrow diffusion angle of the light also allows displays generating images such that each 2D image depends on the angle of observation, and a plurality of 2D images is perceived by the observer's eyes as a 3D image dependent on the angle of observation. in a certain interval of the angles of observation. Angular spatial light modulator isemployed as a display to generate beams directed in several predefined directions, beams being separately encoded for each direction. Scanning of an angle-maintaining diffuser screen by laser impinging onto the diffuser at different angles can be applied to ensure angle-resolved multi-view functionality.

### BRIEF DESCRIPTION OF THE DRAWINGS

FIG. 1. Schematics of a prior art hyperchromatic imaging system.

FIGS. 2A, 2B. Images perceived by an observer from a prior art hyperchromatic imaging system of FIG. 1 for different positions of the observer's eyes. FIG. 2A shows schematically images perceived by the observer's eyes for an observer positioned directly in front of an object.

FIG. 2B shows schematically images perceived by the observer's eye from an observer position at a side from the object.

FIG. 3 shows schematically a hyperchromatic imaging system including a spatial light modulator, according to an embodiment of the present invention.

FIG. 4A illustrates schematically an angular light modulator capable to direct individually coded light beams in several predefined various directions.

FIG. 4B illustrates schematically virtual images perceived by observer's eyes from different perspectives corresponding to the directed beams of FIG. 4A.

FIGS. 5A, 5B. Images perceived by an observer from the hyperchromatic imaging system of FIG. 3 for different positions of the observer's eyes. FIG. 5A shows schematically images perceived by the observer's eyes for an observer positioned directly in front of an object.

FIG. 5B shows schematically images perceived by the observer's eye from an observer position at a side from the object.

FIG. 6. Schematic view of an interactive system composed of: a hyperchromatic imaging system display generating virtual image that is perceived by the observer's eyes as a three-dimensional image, a real object, a camera suitable for taking three-dimensional pictures and an image-processing system, which aligns the geometrical characteristics of a real object with the geometrical characteristics of the virtual image, according to another embodiment of the present invention.

FIG. 7. An optical system combining into a single waveguide the laser light emitted at different wavelengths by the array of distributed feedback lasers, according to another embodiment of the present invention.

FIG. 8A. Formation of a three-dimensional image by directing the laser light at multiple wavelength onto a hyperchromatic optical element having a wavelength-sensitive focal length, wherein the optical element is realized by a converging lens having a wavelength-sensitive focal length, according to yet another embodiment of the present invention.

FIG. 8B. Formation of a three-dimensional image by directing the laser light at multiple wavelength onto a hyperchromatic optical element having a wavelength-sensitive focal length, wherein the optical element is realized by a diverging lens having a wavelength-sensitive focal length, according to a further embodiment of the present invention.

FIG. 9 An optical system, according to a further embodiment of the present invention, wherein separate two-dimensional displays and separated hyperchromatic optical elements are used for red, green and blue light, and forming three-dimensional images are fused into a single full colored three-dimensional image, according to another embodiment of the present invention.

FIG. 10A represents schematically a principle of a scanning optical system allowing to create simultaneously virtual images to be observed from different perspectives.

FIG. 10B represents schematically different beam directions creates simultaneously by the scanning display of FIG. 10A.

FIGS. 11A through 11E illustrate schematically the principle of compensation of the divergence between focal planes of red, green, and blue light. FIG. 11A shows schematically the second hyperchromatic element aimed to compensate the divergence between focal planes of red, green, and blue light, based on three curved mirrors with different focal lengths.

FIG. 11B shows schematically the reflectivity of a red edge filter mounted on a first curved mirror.

FIG. 11C shows schematically the reflectivity of a green edge filter mounted on a second curved mirror.

FIG. 11D shows schematically the reflectivity of a blue edge filter mounted on a third curved mirror.

FIG. 11E shows schematically the three groups of working wavelengths, to which the red, green, and blue edge filters should be adjusted.

FIG. 12A through 12E illustrates schematically the principle of compensation of the divergence between focal planes of red, green, and blue light. FIG. 12A shows schematically the second hyperchromatic element aimed to compensate the divergence between focal planes of red, green, and blue light, based on three diffraction gratings with different angles of diffraction.

FIG. 12B shows schematically the reflectivity of a red edge filter mounted on a first diffraction grating.

FIG. 12C shows schematically the reflectivity of a green edge filter mounted on a second diffraction grating.

FIG. 12D shows schematically the reflectivity of a blue edge filter mounted on a third diffraction grating.

FIG. 12E shows schematically the three groups of working wavelengths, to which the red, green, and blue edge filters should be adjusted.

FIG. 13 shows schematically the light at three basic colors impinging at different angles onto a system of three curved mirrors with edge filters such that light at all colors is focused in the same spatial domain.

FIG. 14 shows schematically an optical system containing two hyperchromatic elements and generating a full color 3D virtual image to be perceived by human's eyes, according to yet another embodiment of the present invention.

FIGS. 15A through 15E illustrate schematically the principle of compensation of the divergence between focal planes of red, green, and blue light. FIG. 15A shows schematically the second hyperchromatic element aimed to compensate the divergence between focal planes of red, green, and blue light, based on three curved mirrors with different focal lengths, according to the same principle as in FIG. 11A.

FIG. 15B shows schematically the reflectivity of a red distributed Bragg reflector (DBR)-based filter mounted on a first curved mirror.

FIG. 15C shows schematically the reflectivity of a green DBR-based filter mounted on a second curved mirror.

FIG. 15D shows schematically the reflectivity of a blue DBR-based filter mounted on a third curved mirror.

FIG. 15E shows schematically the three groups of working wavelengths, to which the red, green, and blue edge filters should be adjusted.

FIG. 16 shows schematically an optical imaging system containing three diffraction each combined with an optical filter such that human's eyes perceive a full color 3D virtual image, according to a further embodiment of the present invention.

### DETAILED DESCRIPTION OF THE INVENTION

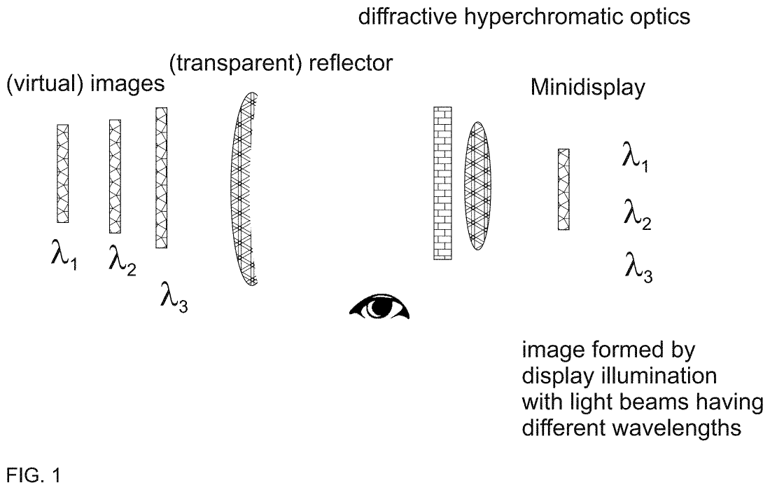

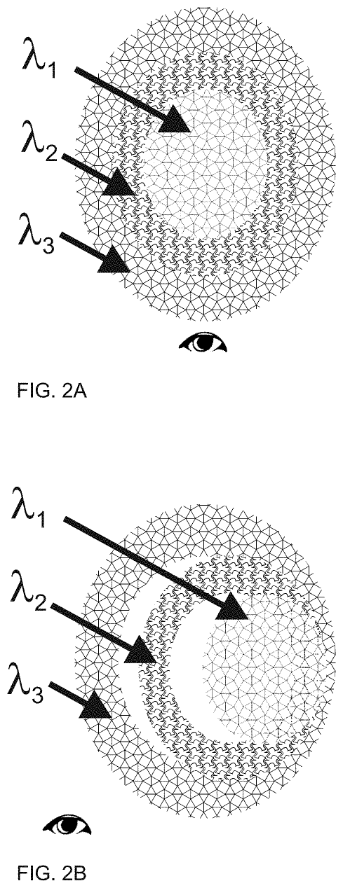

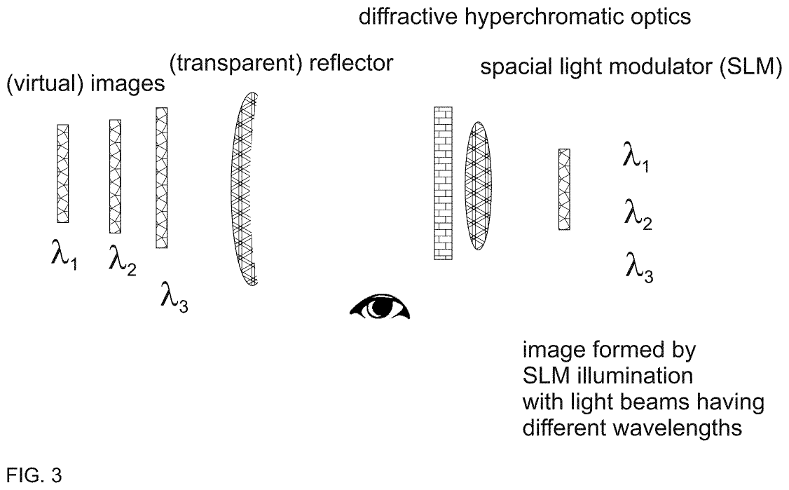

FIG. 3 shows schematically a system for generation of 3D images using hyperchromatic optics, according to an embodiment of the present invention. Spatial light modulator (SLM) is used as a microdisplay. The image is encoded with phase and intensity and under laser illumination this encoding generates an angle encoded image for each plane. Like in the case of hyperchromatic display of FIG. 1 each image plane is coded by a specific wavelength of light. The images are synchronized to generate a full 3D image.

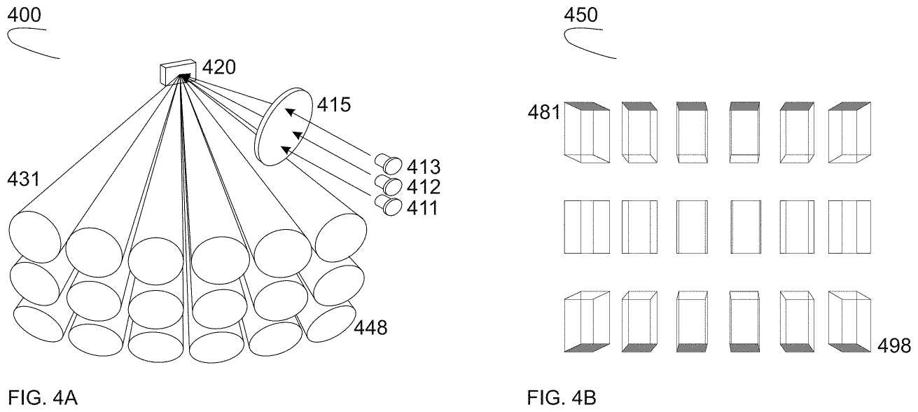

FIGS. 4A and 4B refer to an angular and spatial light modulator. The principle is known in the art, as described, e.g., in the publication “ANGULAR AND SPATIAL LIGHT MODULATOR BY SINGLE MICROMIRROR DEVICE FOR MULTI-IMAGE OUTPUT AND NEARLY-DOUBLED ETENDUE” by Hellman et al., Optics Express, volume 27, issue 15, pp. 21467-21496, Jul. 22, 2019, whereas the publication is hereby incorporated herein in its entirety by reference. An optical imaging system (400) with angular resolution includes an angular and spatial light modulator (420) operating as a digital microdisplay. Laser light from light sources (411), (412) and (413) emitting laser light at different wavelengths impinges via a collimating lens (415) onto the DMD (420). Micromirrors in the DMD (420) are at each time moment rotated such to create a light beam in one of the predefined directions. For illustrative purposes, the system (420) is shown to create light beams in 6×3=18 different directions. Beam #1 labeled (431) and beam #18 labeled (448) are specifically shown.

FIG. 4B illustrates a set (450) of virtual images of the same object observed from different perspectives. The image (481) is observed from perspective #1 corresponding to the beam (431), whereas the image (498) is observed from perspective #18 corresponding to the beam (448). Shaded facets in the top row denote the facet observed from the top, whereas the shaded facets in to bottom row denote the facets observed from the bottom.

The system operates as follows. Once the mirrors of the DMD (420) are rotated such to direct the light in a certain direction, e.g., in the beam (431), the light is encoded such that later, upon diffracting at a hyperchromatic diffractive optical element it will create a virtual image (481) corresponding to the given perspective of view.

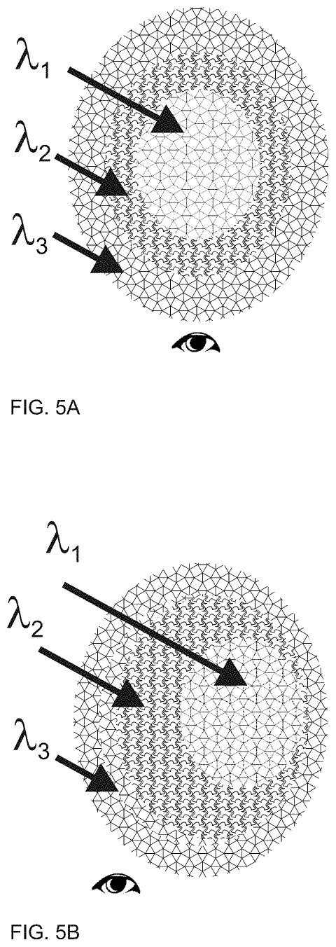

FIGS. 5(a) and 5(b) illustrate schematically a 3D images formed in front of the observer's eyes. For a viewing angle of FIG. 5(a) all image planes are aligned across one viewing direction and the observer receives a 3D non-disturbed image. For a viewing angle of FIG. 5(b), which differs significantly from that of FIG. 5(a), all image planes are aligned across a new viewing direction due to digitally encoded two-dimensional beam steering or hologram effect generated by SLM. The observer perceives a proper 3D image of the object, as if seen from different sides of the real object.

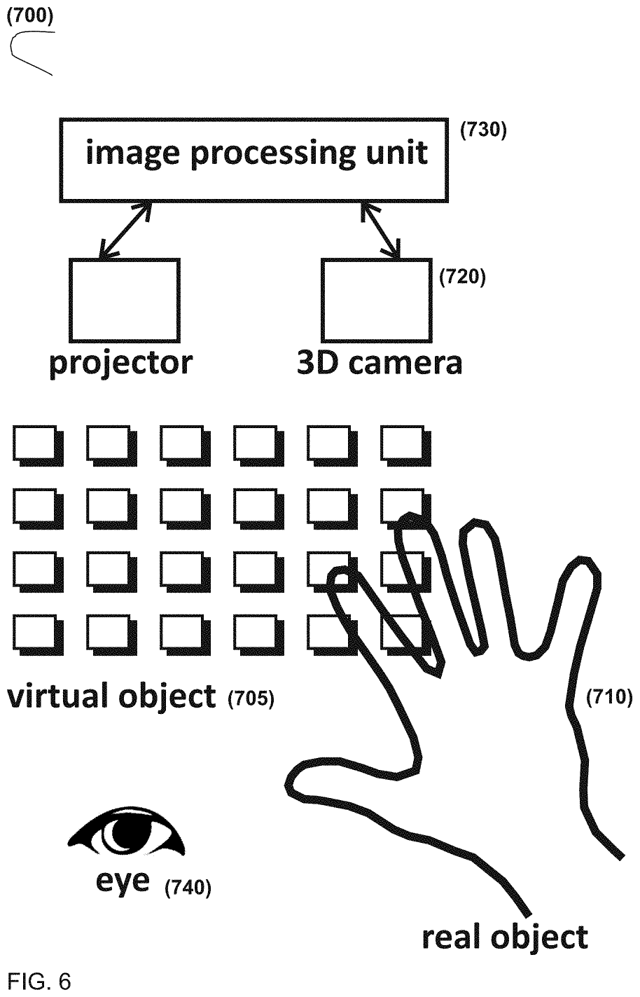

FIG. 6 illustrates a possible application field for 3D displays, namely, an interactive system (700) disclosed in U.S. Pat. Nos. 9,936,193 and 10,205,935. The interactive system (700) is composed of a projection display generating virtual image (705) that is perceived by the operator's eye (operator=observer) (740) as a three-dimensional image, a real object (710), a camera (720) suitable for taking three-dimensional pictures and an image-processing system (730).

For example, a virtual keyboard can be projected as a virtual image that is perceived by the operator's eyes (740) as a 3D image. The hands of the operator are monitored by a three-dimensional camera (720). In FIG. 6 the real object (710) is the operator's hands. Once the operator's hands (710) touches a spatial position, that is empty, but is the position, at which the observer's eyes observe a virtual image of a certain key of the virtual keyboard, the camera (720) monitors this particular position of the operator's hands (710) and transfers the signal to the image-processing system (720). The image processing system (720) processes the signal in the same way as it would process a signal generated by touching a real key on a real keyboard by the operator's hands. Thus, the image-processing system (720) aligns geometrical characteristics of the virtual image (705) with the geometrical characteristics of the real object (710). Such approach can be useful in airspace or automotive industry, where an observer is able to operate a keyboard without deflecting his eyes from observing the space in front of him.

Another realization of an interactive system contains using a real keyboard and a virtual 3D image of the observer's hands. Yet another application uses a virtual keyboard and a virtual image of the observer's hands. All these applications are based on systems generating 3D virtual images. Systems disclosed in the present patent application allow an observer to perceive 3D images once the observation point may change within a certain angle.

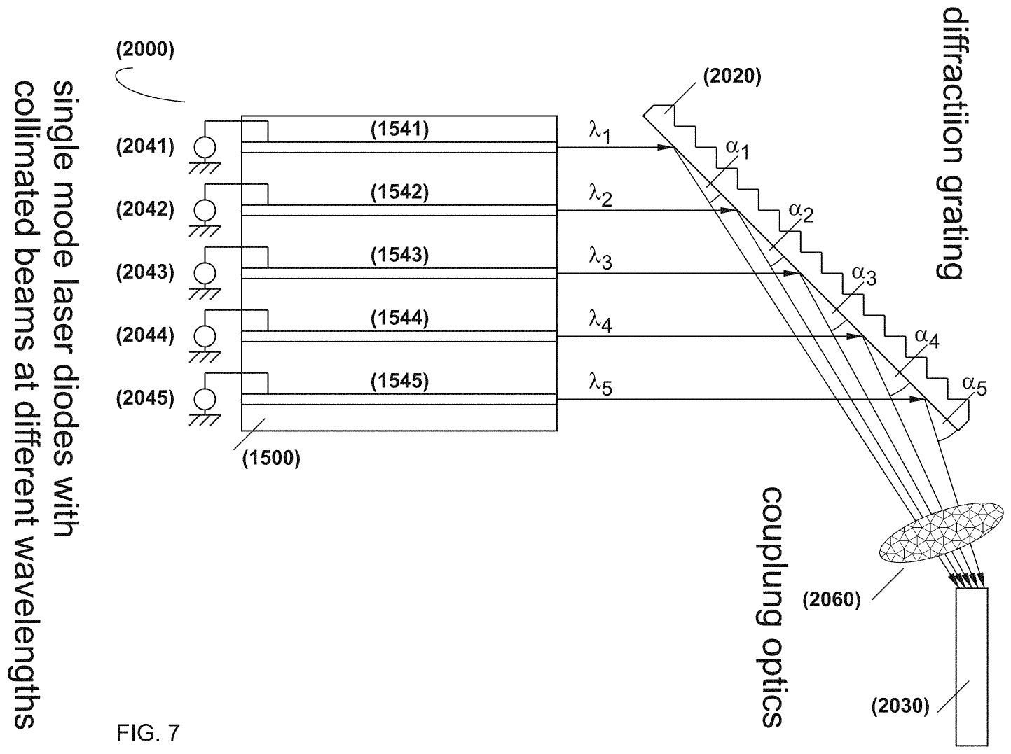

FIG. 7 illustrates an optical system (2000) combining into a single waveguide the laser light emitted at different wavelengths by the array of distributed feedback (DFB) lasers. The set of DFB lasers is fabricated on a single epitaxial wafer (1500). Individual processing of ridge stripes (1541), (1542), (1543), (1544) and (1545) in longitudinal gratings yield an array of single transverse single longitudinal mode lasers emitting laser light at different wavelengths λ₁, λ₂, λ₃, λ₄, λ₅. Each of the distributed feedback lasers of the array is controlled independently by its own driver. The drivers (2041), (2042), (2043), (2044) and (2045) control the DFB lasers (1541), (1542), (1543), (1544) and (1545), respectively. Laser light, emitted by different distributed feedback lasers of the same array, having different wavelengths, impinges on the same diffraction grating (2020). The diffraction grating (2020) is configured such that the light at different wavelengths is diffracted at different angles. Thus, light having wavelengths λ₁, λ₂, λ₃, λ₄, λ₅ is diffracted at angle α₁, α₂, α₃, α₄, as, respectfully. Then, all diffracted light passes through a coupling optical element (2060), e.g. collimating lens, and enters a single waveguide (2030).

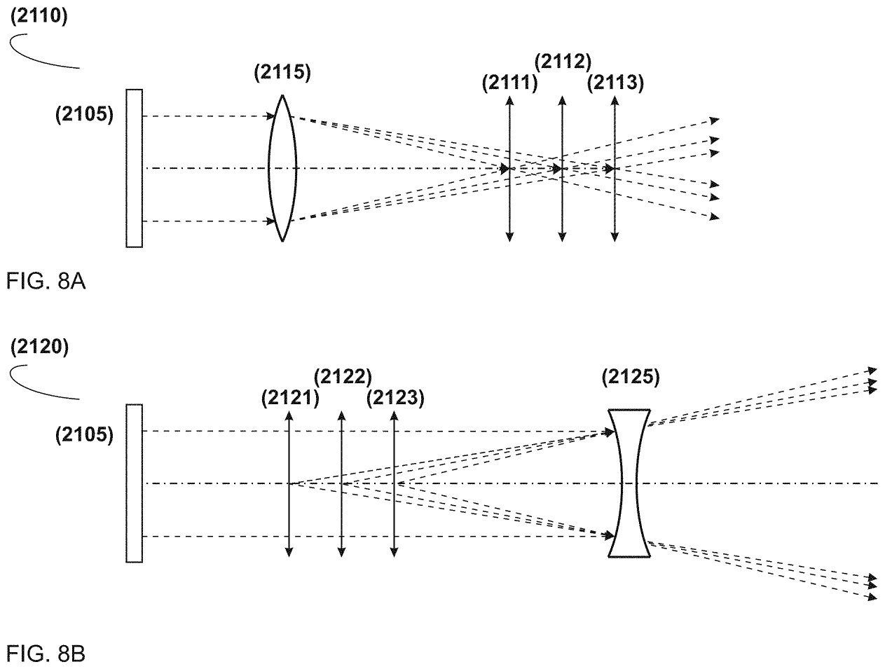

FIGS. 8A and 8B illustrate formation of three-dimensional images by using hyperchromatic optical units having a wavelength-sensitive focal length, according to various embodiments of the present invention. FIG. 8A shows an optical system (2110) comprising a transmissive two-dimensional display (2105) and an optical unit realized by a converging lens (2115). Laser light generated at multiple wavelengths illuminates the two-dimensional display (2105) and transmitted light is further directed onto the converging lens (2115), the focal length of which is wavelength sensitive. FIG. 8A schematically illustrates that light at different wavelengths form real two-dimensional images (2111), (2112), (2113) at different depths and a plurality of images can be perceived by the human's eyes as a three-dimensional image.

FIG. 8B shows an optical system (2120) comprising a transmissive two-dimensional display (2105) and an optical unit realized by a diverging lens (2125), according to a further embodiment of the present invention. Laser light generated at multiple wavelengths illuminates the two-dimensional display (2105) and transmitted light is further directed onto the diverging lens (2125), the focal length of which is wavelength sensitive. FIG. 8B schematically illustrates that light at different wavelengths form virtual two-dimensional images (2121), (2122), (2123) at different depths and a plurality of images can be perceived by the human's eyes as a three-dimensional image.

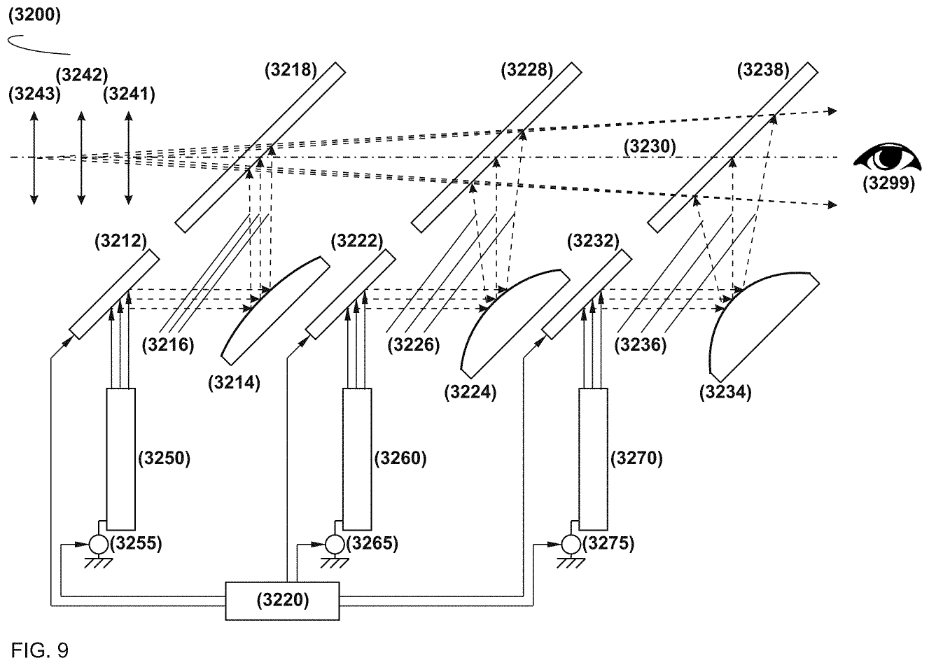

FIG. 9 illustrates schematically an optical system (3200) according to yet another embodiment of the present invention. Optical units having wavelength-sensitive focal lengths are used. Three-dimensional images are created independently for each basic color range and then fused as follows. The multiwavelength source (3250) of laser light in the red color range generates light at a plurality of the wavelengths, all lasers being independently controlled by the drivers (3255). The lasers (3250) illuminate the reflective two-dimensional display (3212). The light reflected from the reflective two-dimensional display (3212) impinges on a hyperchromatic diverging curved mirror (3214). The focal length of the hyperchromatic diverging curved mirror (3214) is wavelength-sensitive. The light (3216) reflected from the hyperchromatic diverging curved mirror (3214) is further reflected from the flat mirror (3218) forming virtual images (3241), (3242), (3243) behind the flat mirror (3218). The light reflected from the flat mirror (3218) is further transmitted through a semitransparent flat mirror (3228) and a semitransparent mirror (3238), both being transparent for red light.

The multiwavelength source (3260) of laser light in the green color range generates light at a plurality of wavelengths, all lasers being independently controlled by the drivers (3265). The lasers (3260) illuminate the reflective two-dimensional display (3222). The light reflected from the reflective two-dimensional display (3222) impinges on a hyperchromatic diverging curved mirror (3224). The focal length of the hyperchromatic diverging curved mirror (3224) is wavelength-sensitive. The light (3226) reflected from the hyperchromatic diverging curved mirror (3224) is further reflected from the flat mirror (3228) forming virtual images behind the flat mirror (3228) and behind the flat mirror (3218). The curvature of the hyperchromatic diverging curved mirror (3224) is preferably larger than the curvature of the hyperchromatic diverging curved mirror (3214), therefore the divergence angle of the light beam (3226) is larger than the divergence angle of the light beam (3216). The divergence angle of the light beam (3226) is configured such that, upon reflection from the flat mirror (3228) the virtual images in the green light are formed at the same location (3241), (3242), (3243) as the virtual images in the red light. Green light is further transmitted through the semitransparent mirror (3238), the mirror (3238) being transparent for green light.

The multiwavelength source (3270) of laser light in the blue color range generates light at a plurality of wavelengths, all lasers being independently controlled by the drivers (3275). The lasers (3270) illuminate the reflective two-dimensional display (3232). The light reflected from the reflective two-dimensional display (3232) impinges on a hyperchromatic diverging curved mirror (3234). The focal length of the hyperchromatic diverging curved mirror (3234) is wavelength-sensitive. The light (3236) reflected from the hyperchromatic diverging curved mirror (3234) is further reflected from the flat mirror (3238) forming virtual images behind the flat mirrors (3238), (3228), (3218). The curvature of the hyperchromatic diverging curved mirror (3234) is preferably larger than the curvature of the hyperchromatic diverging curved mirror (3224), therefore the divergence angle of the light beam (3236) is larger than the divergence angle of the light beam (3226). The divergence angle of the light beam (3236) is configured such that, upon reflection from the flat mirror (3238) the virtual images in the blue light are formed at the same location (3241), (3242), (3243) as the virtual images in the red and in the green light.

A possible way to configure the flat mirrors (3218), (3228) and (3238) can be chosen as but is not limited to the following one. All three flat mirrors (3218), (3228) and (3238) can be configured as distributed Bragg reflectors. The spectral position of the reflectivity stopbands can be chosen such that the mirror (3218) is reflecting to the red light, the mirror (3228) is transparent to the red light, but reflecting to the green light, and the mirror (3238) is transparent to the red and green light, but reflecting to the blue light.

Control signals generated by the control system (3220) and sent to the laser drivers (3255), to the display (3212), to the laser drivers (3265), to the display (3222), to the laser drivers (3275), to the display (3232) are configured such that the human's eyes (3299) perceive a fully colored three-dimensional image.

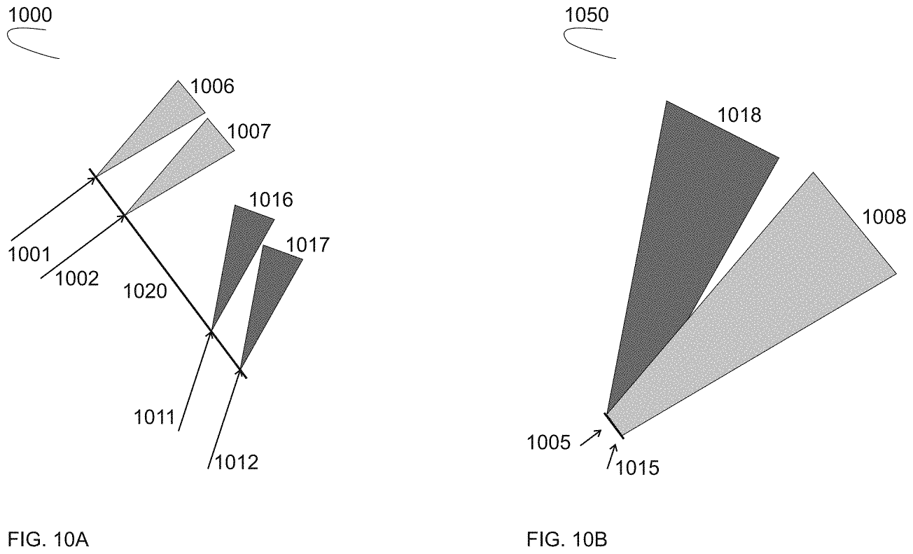

An alternative way of creation an angle-resolved hyperchromatic 3D system is illustrated in FIGS. 10A and 10B, according to yet another embodiment of the present invention. The scanning system (1000) includes a display (1020) operating as a deterministic diffuser. The diffuser is a high gain angle-maintaining diffuser configured such to increase brightness of the diffused light beam in the targeted angle range. In one embodiment impinging light (1001) is diffused in an angle (1006), whereas impinging light (1002) is diffused in an angle (1007). The angle is preferably smaller than 50 degrees in each cross-section plane. In another embodiment the diffuser (1020) is illuminated by multiple light sources, each impinging at a different angle. It is preferred that the light aimed to create a virtual 2D image at a certain depth once observed from one angle and light aimed to create a virtual 2D image at the same depth once observed from another angle were light at the same spectral range, preferably with a difference below 1 nanometer such that the virtual 2D images appear nearly at the same depth. FIG. 10A shows light (1001) and (1002) impinging at one angle, whereas (1011) and (1012) denotes light impinging at the diffuser (1020) at a different angle. Light (1011) is diffused in an angle (1016), whereas light (1012) is diffused in an angle (1017).

We note here that, once the divergence angle of the diffused beam is below 50 degrees in each cross-section plane, the solid angle of the diffused beam is below one tenth of the solid angle of the hemisphere. Thus, such a diffused has a brightness at least 10 times higher than the brightness of the isotropic diffuser.

Diffused light perceived by observer's eyes depends on the position of the observer. At one position, observer perceives light (1006) and (1007) propagating in one direction. Further, light perceived by two eyes of the observer (1006) and (1007) creates a stereoscopic effect, which does not suffer from vergence-accommodation conflict asthe hyperchromatic effect determining the distance between the planes matches the stereoscopic effect which induces the perception of distance.

At a second position of the obserever's eyes, observer perceives light (1016) and (1017).

The scanning system (1000) operates as follows. For each of the preselected angles of incidence and for each of the preselected wavelengths, the impinging laser light is scanning across the diffuser (1020). Light at a given wavelengths and at a given angle of incidence is scanning across the diffuser independently from the light at a different wavelength or at a different angle of incidence.

FIG. 10B illustrates functionality of the entire diffuser (1050). All light impinging at different points of the diffuser (1020) in one direction (1005) diffuses to form scattered light (1008) emitted within a certain angle. All light impinging at different points of the diffuser (1020) in another direction (1015) diffuses to form scattered light (1018) emitted within a different angle.

The advantage of scanning system (1000), (1050) over the system based on a DMD of FIG. 4 is that the laser light directed at all preselected angles and for all the wavelengths needed for generation of hyperchromatic 3D images illuminates the display (diffuser) simultaneously. The disadvantage is that the scanning system requires independent laser source for each of the preselected angles, while DMD can deflect the light from the same source to distribute it to the targeted angles.

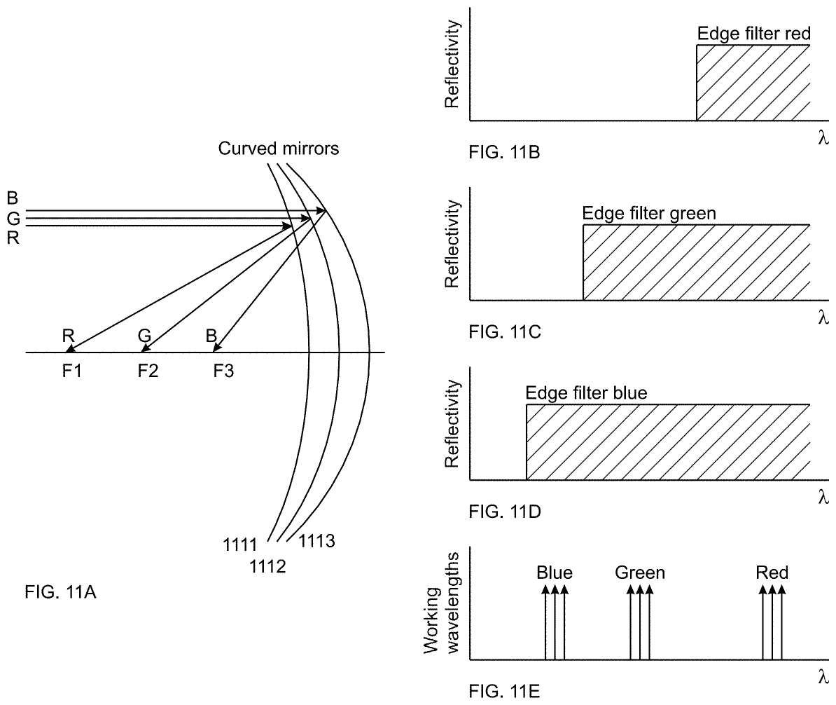

FIGS. 11A through 11E illustrate an approach to combine red, green and blue images into a single full-colored image, an approach alternative one to that of FIG. 9. Red, green, and blue light impinges onto an optical system consisting of three curved mirrors with different curvature. The first curved mirror (1111) is covered by an optical edge red filter, which reflectivity is plotted in FIG. 11B. The second curved mirror (1112) is covered by an optical edge green filter, which reflectivity is plotted in FIG. 11C. The third curved mirror (1113) is covered by an optical edge blue filter, which reflectivity is plotted in FIG. 11D. FIG. 11E depicts a plurality of red wavelengths, a plurality of green wavelengths, and a plurality of blue wavelengths, corresponding to all wavelengths of light emitted by the display and present in the red, green and blue light in FIG. 11A, light impinging onto a system composed of three curved mirrors. Red light is mostly reflected by the edge red filter deposited onto a first curved mirror (1111). This mirror has the minimum curvature among all three mirrors, and, hence, the maximum focal length. A particular feature of the edge red filter of FIG. 11B is that the reflectivity of the light is the same at all wavelengths present among red light in FIG. 11E. All red light is then collimated in the focus F1.

Edge red filter of FIG. 11B is transparent for the green light, and the green light is transmitted through the first curved mirror (1111) and impinges onto the second curved mirror (1112). Green light is reflected from the second curved mirror (1112) by the green edge filter. Since the curvature of the second curved mirror (1112) is larger than that of the first curved mirror (1111), the focal length is shorter, and the green light is focused in the focus F2.

Both edge red filter of FIG. 11B and edge green filter of FIG. 11C are transparent for blue light, and blue light is transmitted through the first curved mirror (1111) and the second curved mirror (1112) and impinges onto the third curved mirror (1113). Blue light is reflected from the third curved mirror (1113) by the blue edge filter. Since the curvature of the third curved mirror (1113) is larger than both the curvature of the first curved mirror (1111) and the second curved mirror (1112), the focal length of the third curved mirror (1113) is the shortest among the three. The blue light is thus focused at the focus F3, the closest one to the mirrors.

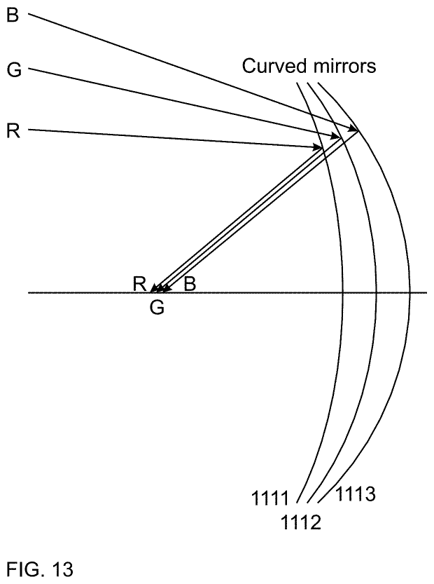

FIG. 13 illustrates practical implementation of the hyperchromatic optical element of FIG. 11A. Red, green, and blue light impinge at the system of three curved mirrors within different angle ranges defined by hyperchromatic optics causing different focal points for different wavelength ranges. As the curvature of the reflection surface is different for each of the basic colors, the focal length is also different as shown in FIG. 11A. Thus, the divergence angles of the light at all three basic colors and the focal lengths are configured such, that all beams are focused in the same spatial domain. As the focus correction effect occurs only between different spectral ranges, but not within the same basic color range, the hyperchromatic effect is maintained for each of the wavelength ranges.

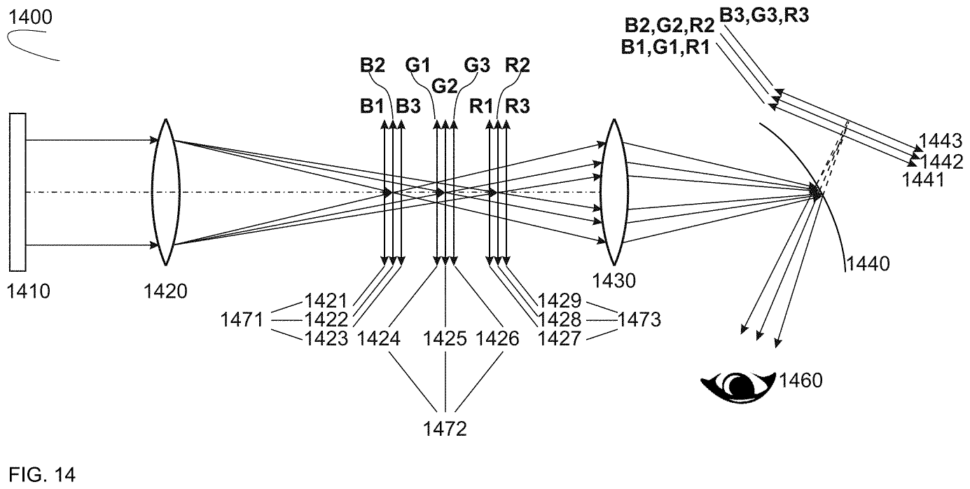

FIG. 14 shows schematically an entire optical imaging system (1400) implementing the approach of FIGS. 11A through 11E and FIG. 13, according to an embodiment of the present invention. A display (1410) incorporating an angular spatial modulator emit laser light at all operational wavelengths in all basic colors, namely, red, green, and blue. All light goes through a first hyperchromatic optical element (1420). Blue light at different wavelengths is focused in a first spatial domain (1471). For clarity, light at three wavelengths is shown. Light B1 is focused at the point (1421). Light B2 is focused at the point (1422). Light B3 is focused at the point (1423). Green light at different wavelengths is focused in a second spatial domain (1472). For clarity, light at three wavelengths is shown. Light G1 is focused at the point (1424). Light G2 is focused at the point (1425). Light G3 is focused at the point (1426). Red light at different wavelengths is focused in a third spatial domain (1473). For clarity, light at three wavelengths is shown. Light R1 is focused at the point (1427). Light R2 is focused at the point (1428). Light R3 is focused at the point (1429).

Further all light goes through a collimating optical element (1430) and impinges on a second hyperchromatic element (1440). A system of three curved mirrors with different curvatures, each mirror having an edge filter deposited thereon, as illustrated in FIGS. 11A through 11E and FIG. 13 can be implemented. A large shift between positions of images created by red light and by green light, created by green light and blue light, is then compensated by a second hyperchromatic element (1440). At the same time a small shift between the images created at different wavelengths within the same red spectral range, or between the images created at different wavelengths within the same green spectral range, or between the images created at different wavelengths within the same blue spectral range persist. Thus, light at wavelengths B1, G1, and R1 create a virtual image at the same plane (1441). Light at wavelengths B2, G2, and R2 create a virtual image at the same plane (1442). Light at wavelengths B3, G3, and R3 create a virtual image at the same plane (1443). The observer's eyes (1460) perceive a full colored 3D virtual image.

In practical systems there will be some tolerances between the positions of the image planes created by light in a one basic color range and the positions of the images created by light in a second basic color range. It is preferred that the separation between the image R1 and G1, between G1 and B1, between B1 and R1 does not exceed one half of the separation between R1 and R2, of the separation between G1 and G2, of the separation between B1 and B2. Similar targets are set for the other individual wavelengths of light.

It is also possible that the number of operational wavelengths in red and green, or in green and blue, or in blue and red spectral range is different. Then, to enable that an observer perceives a full colored 3D image it is preferred that the closest to the observer's eyes image planes in red, green and blue would be nearly the same position, and that the most remote from the observer's eyes image plane in red, green, and blue would be nearly at the same position. The preferred tolerance is one half of the minimum separation between two image planes within the same basic color range.

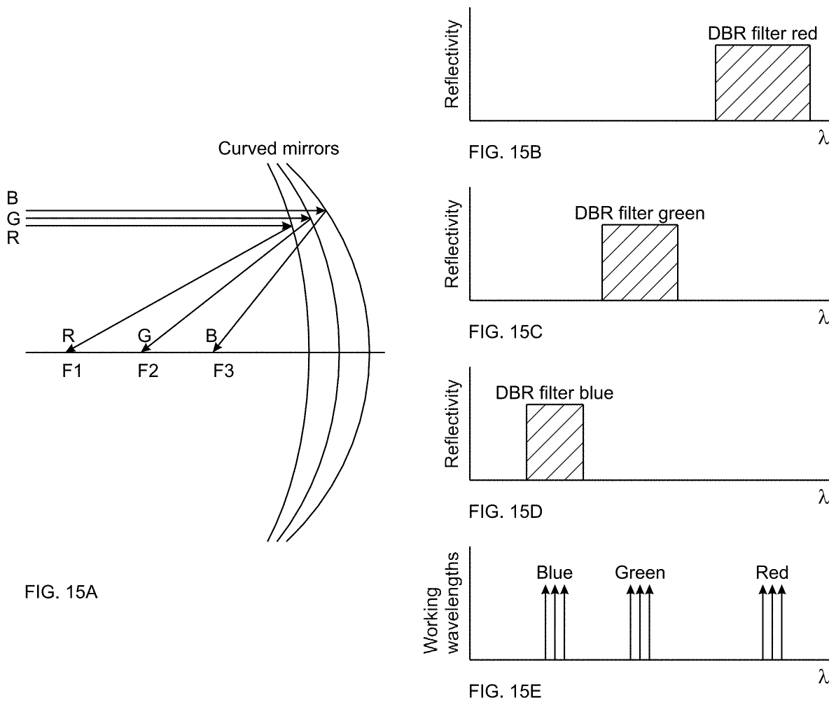

FIGS. 15A through 15E illustrate schematically a second hyperchromatic element aimed to combine light in the red spectral range, light in the green spectral range, and light in the blue spectral range such that an observer perceives a full-colored 3D image, according to another embodiment of the present invention. Unlike the embodiment of FIGS. 11A through 11E, the red, green and blue filters, which reflectivity spectra are displayed in FIGS. 15B, 15C, and 15D, respectively, are no longer edge filters, but filters having non-overlapping reflectivity stopbands. Such filter can be realized, e. g., as distributed Bragg reflector-(DBR) filters. Reflectivity ranges can be adjusted, for example, by selecting materials used in DBRs having a relatively low refractive index contrast. In another approach DBR layers can have thicknesses different from one quarter of a wavelength in the material at the same periodicity defined by the central stopband wavelength of such reflector.

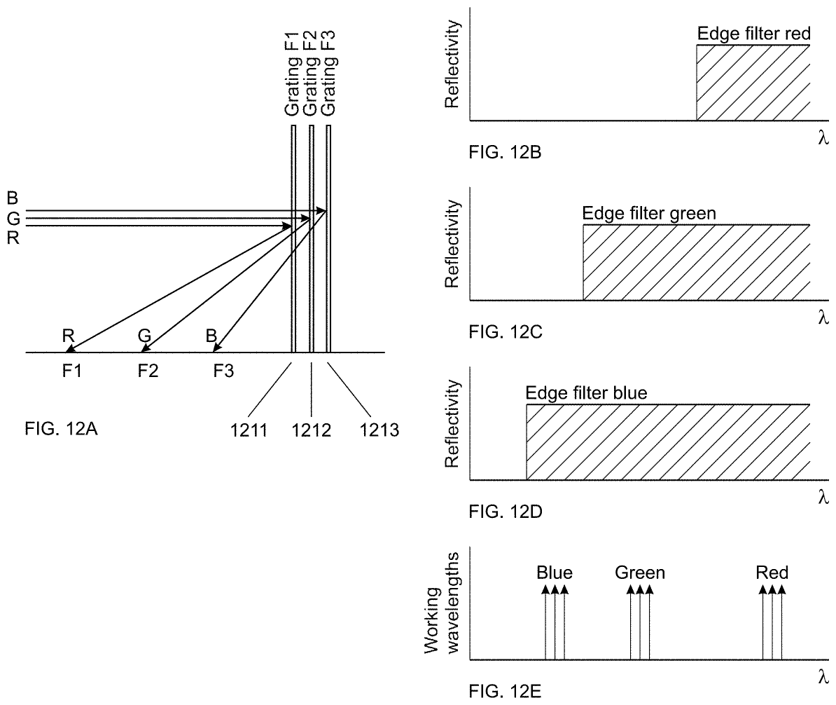

FIGS. 12A through 12E represent schematically a second hyperchromatic element aimed to combine light in the red spectral range, light in the green spectral range, and light in the blue spectral range such that an observer perceives a full-colored 3D image, according to yet another embodiment of the present invention.

Light in all colors impinges onto a systems composed of three diffraction gratings (1211), (1212), and (1213). The first diffraction grating (1211) is covered by a red edge filter, which reflectivity spectrum is plotted in FIG. 12B. Red light is reflected and diffracted by the grating (1211). The grating is configured such that the major part of reflected light is directed to a point F1.

Grating (1211) is transparent for green light. The green light is transmitted through the grating (1211) and impinges onto a second grating (1212). The second grating (1212) is covered by a green edge filter, which reflectivity spectrum is plotted in FIG. 12C. The green light is reflected and diffracted by the second grating (1212). The diffraction grating (1212) is configured such that the major part of light is directed at a different angle to the point F2.

Both grating (1211) and (1212) are transparent for blue light. The blue light is transmitted through the first grating (1211) and through the second grating (1212) and impinges onto a third grating (1213). The third grating (1213) is covered by a blue edge filter, which reflectivity spectrum is plotted in FIG. 12D. The blue light is reflected and diffracted by the third grating (1213). The diffraction grating (1213) is configured such that the major part of light is directed at a different angle to the point F3.

A one skilled in the art will appreciate that using three diffraction gratings covered by filters will allow to combine red, green, and blue light impinging onto a system at different angles, and to direct all light to the same domain, similar to the illustration of FIG. 13.

Furthermore, an optical imaging system similar to that shown in FIG. 14 is possible. The second hyperchromatic element aimed to combine light in red, green, and blue spectral ranges can be applied, whereas three diffraction gratings are used instead of three curved mirrors. The system will enable an observer to perceive a full-colored 3D virtual image.

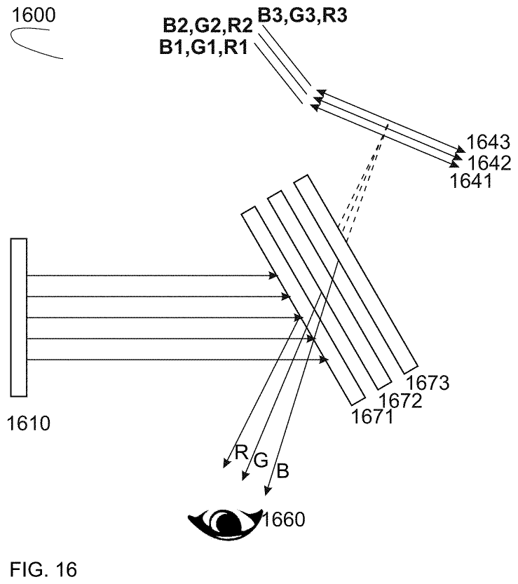

FIG. 16 shows schematically an optical imaging system (1600) according to a further embodiment of the present invention. A display (1610) emits laser light at all operational wavelengths in all basic colors, namely, red, green, and blue. For definiteness we denote multiple red wavelengths R1, R2, R3, multiple green wavelengths G1, G2, G3, and multiple blue wavelengths B1, B2, B3. All light impinges onto a single hyperchromatic structure composed of three sub-structures, (1671), (1672), and (1673).

The sub-structure (1671) contains a selective reflector, reflecting electively only red light, e.g., a DBR-based reflector and a hyperchromatic element, e.g., a Fresnel zone plate. The Fresnel zone plate is based, however, not on a pattern with a high refractive index contrast, like glass/air, but on a week contrast within the DBR structure. Thus, such Fresnel zone plate will operate like a hyperchromatic element only for red light which is being reflected by the sub-structure (1671), and will remain transparent and non-diffractive for green and blue light. The hyperchromatic effect of the sub-structure (1671) results in the formation of virtual images at different planes, plane (1641) for R1, plane (1642) for R2, and plane (1643) for R3.

Green light is transmitted through a transparent for green light sub-structure (1671) and impinges onto a sub-structure (1672). The sub-structure (1672) contains a selective reflector, reflecting electively only green light, e.g., a DBR-based reflector and a hyperchromatic element, e.g., a Fresnel zone plate. The Fresnel zone plate is based, however, not on a pattern with a high refractive index contrast, like glass/air, but on a week contrast within the DBR structure. Thus, such Fresnel zone plate will operate like a hyperchromatic element only for green light which is being reflected by the sub-structure (1672), and will remain transparent and non-diffractive for blue light. The hyperchromatic effect of the sub-structure (1672) results in the formation of virtual images at different planes, plane (1641) for G1, plane (1642) for G2, and plane (1643) for G3.

Blue light is transmitted through a transparent for blue light sub-structures (1671) and (1672) and impinges onto a sub-structure (1673). The sub-structure (1673) contains a selective reflector, reflecting electively only green light, e.g., a DBR-based reflector and a hyperchromatic element, e.g., a Fresnel zone plate. The Fresnel zone plate is based, however, not on a pattern with a high refractive index contrast, like glass/air, but on a week contrast within the DBR structure. Thus, such Fresnel zone plate will operate like a hyperchromatic element for blue light which is being reflected by the sub-structure (1673). The hyperchromatic effect of the sub-structure (1673) results in the formation of virtual images at different planes, plane (1641) for B1, plane (1642) for B2, and plane (1643) for B3.

The three Fresnel zone plates (or other hyperchromatic lens elements), each formed within a reflector of either red or green or blue light, are configured such, that the planes, at which virtual images at red light R1, at green light G1, and at blue light B1 form virtual images, coincide within a reasonable tolerance at the same plane (1641). Similarly, the planes, at which virtual images at red light R2, at green light G2, and at blue light B2 form virtual images, coincide within a reasonable tolerance at the same plane (1642). The planes, at which virtual images at red light R3, at green light G3, and at blue light B3 form virtual images, coincide within a reasonable tolerance at the same plane (1643).

This, by using a single hyperchromatic element composed of three Fresnel zone plates integrated into DBR reflectors, it is possible to create a virtual image which will be perceived by human's eyes (1660) as a full-colored 3D virtual image. For certain applications, for example, for head up displays used in automotive industry and in vehicles in general, the reflectivity of the DBR-based element can be selected to be low, for example, below 5%. In such case the driver will see superpositions of real and virtual images even if the DBR reflectors are formed directly on the windshield.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. Different types of displays allowing the demanded functionality can be used. Microlaser array displays can be applied if the spectral range for each basic color is distributed between the display pixels. Different laser sources and laser arrays can be applied (edge-emitting, surface-emitting, single mode, multimode) once these provide necessary power and meet resolution targets.

Although the invention has been illustrated and described with respect to exemplary embodiments thereof, it should be understood by those skilled in the art that the foregoing and various other changes, omissions and additions may be made therein and thereto, without departing from the spirit and scope of the present invention. Therefore, the present invention should not be understood as limited to the specific embodiments set out above but to include all possible embodiments which can be embodied within a scope encompassed and equivalents thereof with respect to the feature set out in the appended claims.

What is claimed is:

1. A hyperchromatic optical imaging system for generating images that are perceived as three-dimensional images by the observer's eyes,
whereas said hyperchromatic optical imaging system comprises
a) laser illumination sources at least two distinct wavelengths,
whereas said laser illumination sources at least two distinct wavelengths are encoded independently,
b) at least one two-dimensional display further comprising
an element suitable for generating different images at least two distinct viewing angles,
c) a hyperchromatic optical element having a wavelength-dependent focal length,
d) an optical system composed of lens or lenses and/or mirror or mirrors,
whereas said optical system provides images separated in depth and dependent on a viewing angle,
whereas images generated are synchronized with illumination wavelengths of said laser illumination sources, such that images are created at different depths such that
an observer perceives a complete three-dimensional image dependent on the viewing angle.

2. A hyperchromatic optical imaging system for generating images that are perceived as three-dimensional images by the observer's eyes,
whereas said hyperchromatic optical imaging system comprises:
a) laser illumination sources at least two distinct wavelengths,
whereas said laser illumination sources at least two distinct wavelengths are encoded independently,
b) at least one two-dimensional display,
whereas said at least one two-dimensional display is a high gain diffusor,
whereas said high gain diffusor is a diffusor, such that
light scattered from each element of said diffusor has beam divergence in each of the cross section planes not exceeding fifty degrees full width at half maximum,
c) a hyperchromatic optical element having a wavelength-dependent focal length,
d) an optical system composed of lens or lenses and/or mirror or mirrors,
whereas said optical system provides images separated in depth and dependent on a viewing angle,
whereas images generated are synchronized with illumination wavelengths of said laser illumination sources, such that images are created at different depths such that
an observer perceives a complete three-dimensional image at the selected viewing angle at increased brightness,
whereas said increased brightness exceeds the brightness of an isotropic diffuser at least by a factor of five.

3. A hyperchromatic optical imaging supersystem for generating images, whereas said hyperchromatic optical imaging supersystem comprises
a) hyperchromatic optical imaging system of claim 1 or 2,
whereas said laser illumination sources operate at a first basic color range, and
b) hyperchromatic optical imaging system of claim 1 or 2,
whereas said laser illumination sources operate at a second basic color range, and
c) hyperchromatic optical imaging system of claim 1 or 2,
whereas said laser illumination sources operate at a third basic color range,
whereas said first, second, and third color ranges are distinct color ranges selected from the group consisting of:
A) red color range,
B) green color range, and
C) blue color range; and
whereas generated three-dimensional images in said first, second, and third basic color ranges are combined to form a fully colored three-dimensional image dependent on the viewing angle,
whereas said generated three-dimensional images in said first, second, and third basic color ranges are combined by a means selected from the group consisting of:
A) an optical filter,
B) a lens having an adjustable focus,
C) a mirror having an adjustable focus,
D) a diffraction grating having an adjustable diffraction pattern,
D) a lens stack with separate focus for each lens element, where each lens element is active for particular color range,
E) a mirror stack with separate focus for each mirror element, where each mirror element is active for particular color range; and
F) any combination of A) through E).

4. A hyperchromatic optical imaging supersystem of claim 3,
whereas said optical filter is selected from the group consisting of:
i) an edge optical filter with onset wavelength at a particular wavelength range, and
ii) a distributed Bragg reflector-based optical filter with stopband matching a particular basic wavelength range.

5. A hyperchromatic optical imaging system of claim 1,
whereas said element suitable for generating different images at least two distinct viewing angles is an angular spatial light modulator selected from the group consisting of:
a) a digital light processing angular spatial light modulator, and
b) a liquid crystal technology on Silicon (LCoS) angular spatial light modulator.

6. A hyperchromatic optical imaging supersystem of claim 3 comprising
a) a first multiple wavelength laser source capable to emit laser light at a first plurality of wavelengths in a first basic color range,
b) at least one second multiple wavelength laser source capable to emit laser light at a second plurality of wavelengths in a second basic color range,
wherein said second basic color range is distinct from said first basic color range,
c) at least one two-dimensional display illuminated by
i) laser light at a first wavelength from said first plurality of wavelengths and
ii) laser light at least one second wavelength from said first plurality of wavelengths,
wherein said at least one second wavelength from said first plurality of wavelengths is distinct from said first wavelength from said first plurality of wavelengths,
iii) laser light at a first wavelength from said second plurality of wavelengths and
iv) laser light at least one second wavelength from said second plurality of wavelengths,
wherein said second wavelength from said second plurality of wavelengths is distinct from said first wavelength from said second plurality of wavelengths,
whereas said two-dimensional display is an angular selective display,
d) at least one hyperchromatic optical unit,
wherein said at least one hyperchromatic optical unit further comprises
A) a first hyperchromatic optical element, having a focal length,
wherein said focal length of said first hyperchromatic optical element is different for different wavelengths, and
B) at least one second hyperchromatic optical element having an adjustable focal length,
wherein said adjustable focal length can be adjusted by a means selected from the group of means consisting of:
i) applying relative motion of said at least one second optical element and said at least one two-dimensional display,
ii) applying deformation to said at least one second optical element,
iii) applying electro-optic effect in an external electric field to said at least one second optical element,
iv) any combination of i) through iii),
wherein said at least one hyperchromatic optical unit creates a first plurality of two-dimensional images of said at least one two-dimensional display formed by light at said first plurality of wavelengths,
wherein said first plurality of two-dimensional images has a first mean position,
wherein said first plurality of two-dimensional images has a first spreading of positions,
wherein said at least one optical hyperchromatic unit creates a second plurality of two-dimensional images of said at least one two-dimensional display formed by light at said second plurality of wavelengths,
wherein said second plurality of two-dimensional images has a second mean position,
wherein said second plurality of two-dimensional images has a second spreading of positions,
e) a control system,
wherein said control systems synchronizes
AA) a state of said at least one two-dimensional display,
BB) intensity modulation of laser light of said first multiple wavelength laser source,
CC) intensity modulation of laser light of said second multiple wavelength laser source, and
DD) a signal set to adjust said adjustable focal length of said at least one second optical element,
such that the observer's eyes perceive said first plurality of two-dimensional images of said at least one two-dimensional display as a three-dimensional image in said first basic color range,
such that the observer's eyes perceive said second plurality of two-dimensional images of said at least one two-dimensional display as a three-dimensional image in said second basic color range,
such that said adjustable focal length of said at least one second optical element is adjusted such as said adjustment compensates a change of said optical length of said first optical element due to switch of light between said first basic color range and said second basic color range,
wherein said compensation results in fusion of said three-dimensional image in said first basic color range and said three-dimensional image in said second basic color range,
wherein said fusion means that said three-dimensional image in said first basic color range and said three-dimensional image in said second basic color range overlap in space,
wherein said overlapping in space means than a distance between said second mean position and said first mean position is
AAA) smaller than fifty percent of said first spreading of positions and
BBB) smaller than fifty percent of said second spreading of positions,
wherein the observer's eyes perceive said first plurality of two-dimensional images of said at least one two-dimensional display and said second plurality of two-dimensional images of said at least one two-dimensional display as a single fully colored three-dimensional image.

7. The hyperchromatic optical imaging supersystem of claim 3 comprising
a) a first multiple wavelength laser source capable to emit laser light at a first plurality of wavelengths in a first basic color range,
b) at least one second multiple wavelength laser source capable to emit laser light at a second plurality of wavelengths in a second basic color range,
wherein said second basic color range is distinct from said first basic color range,
c) at least one two-dimensional display illuminated by
i) laser light at a first wavelength from said first plurality of wavelengths and
ii) laser light at least one second wavelength from said first plurality of wavelengths,
wherein said at least one second wavelength from said first plurality of wavelengths is distinct from said first wavelength from said first plurality of wavelengths,
iii) laser light at a first wavelength from said second plurality of wavelengths and
iv) laser light at least one second wavelength from said second plurality of wavelengths,
wherein said second wavelength from said second plurality of wavelengths is distinct from said first wavelength from said second plurality of wavelengths,
whereas said two-dimensional display is an angular spatial light modulator,
d) a first hyperchromatic optical element, having a focal length,
wherein said focal length of said first hyperchromatic optical element is different for different wavelengths, and
e) at least one combining optical element having a focal length distinct between a first focal length for the light at the wavelengths from said first plurality of wavelengths and a second focal length for the light at the wavelengths from said second plurality of wavelengths,
wherein said at least one combining optical element further comprises:
i) a first optical subelement transparent for the light at the wavelengths from said second plurality of wavelengths, and focusing light at the wavelengths from said first plurality of wavelengths with a first focal length; and
ii) a second optical subelement focusing light at the wavelengths from said second plurality of wavelengths with a second focal length;
wherein said first hyperchromatic optical element and said at least one combing optical element create a first plurality of two-dimensional images of said at least one two-dimensional display formed by light at said first plurality of wavelengths,
wherein said first plurality of two-dimensional images has a first mean position,
wherein said first plurality of two-dimensional images has a first spreading of positions,
wherein said first hyperchromatic optical element and said at least one combing optical element create a second plurality of two-dimensional images of said at least one two-dimensional display formed by light at said second plurality of wavelengths,
wherein said second plurality of two-dimensional images has a second mean position,
wherein said second plurality of two-dimensional images has a second spreading of positions,
wherein said second mean position coincides with said first mean position, and
wherein coincidence means that
a distance between said second mean position and said first mean position is
AAA) smaller than fifty percent of said first spreading of positions, and
BBB) smaller than fifty percent of said second spreading of positions,
wherein said second spreading of positions coincides with said first spreading of positions,
wherein a distance between the closest to the observer's eye position of a two-dimensional image of said second plurality of two-dimensional images and the closest to the observer's eye position of a two-dimensional image of said first plurality of two-dimensional images is
AAA) smaller than fifty percent of said first spreading of positions, and
BBB) smaller than fifty percent of said second spreading of positions,
wherein the observer's eyes perceive a single fully colored three-dimensional image.

8. The hyperchromatic optical imaging supersystem of claim 3 comprising
a) a first multiple wavelength laser source capable to emit laser light at a first plurality of wavelengths in a first basic color range,
b) at least one second multiple wavelength laser source capable to emit laser light at a second plurality of wavelengths in a second basic color range,
wherein said second basic color range is distinct from said first basic color range,
c) at least one two-dimensional display illuminated by
i) laser light at a first wavelength from said first plurality of wavelengths and
ii) laser light at least one second wavelength from said first plurality of wavelengths,
wherein said at least one second wavelength from said first plurality of wavelengths is distinct from said first wavelength from said first plurality of wavelengths,
iii) laser light at a first wavelength from said second plurality of wavelengths and
iv) laser light at least one second wavelength from said second plurality of wavelengths,
wherein said second wavelength from said second plurality of wavelengths is distinct from said first wavelength from said second plurality of wavelengths,
whereas said two-dimensional display is an angular spatial light modulator,
d) a first hyperchromatic optical element, having an optical filter configured such that
A) said first hyperchromatic optical element is transparent for the light at the wavelengths from said second plurality of wavelengths, and
B) said first hyperchromatic optical element creates a first plurality of two-dimensional images of said at least one two-dimensional display formed by light at the wavelengths from said first plurality of wavelengths,
wherein said first plurality of two-dimensional images has a first mean position,
wherein said first plurality of two-dimensional images has a first spreading of positions, and
e) a second hyperchromatic optical element,
wherein said second hyperchromatic optical element creates a second plurality of two-dimensional images of said at least one two-dimensional display formed by light at the wavelengths from said second plurality of the wavelengths,
wherein said second plurality of two-dimensional images has a second mean position,
wherein said second plurality of two-dimensional images has a second spreading of positions,
wherein said second mean position coincides with said first mean position, and
wherein said second spreading of positions coincides with said first spreading of positions, and
wherein the observer's eyes perceive a single fully colored three-dimensional image.

9. A hyperchromatic optical imaging system for generating images that are perceived as three-dimensional images by the observer's eyes,
whereas said hyperchromatic optical imaging system comprises
a) a scanning projection display having a screen with reduced divergence of the light scattered at each spot upon an impinging laser beam,
whereas reduced divergence of said scattered light does not exceed fifty degrees full width at half maximum at least in one of the directions perpendicular to the direction of said impinging laser beam,
b) at least four laser illumination sources,
whereas said at least four laser illumination sources comprise
AA) a laser illumination source at a first wavelength impinging on said scanning projection display at a first angle of incidence,
BB) a laser illumination source at said first wavelength impinging on said scanning projection display at a second angle of incidence, distinct from said first angle of incidence,
CC) a laser illumination source at a second wavelength distinct from said first wavelength impinging on said scanning projection display at said first angle of incidence, and
DD) a laser illumination source at a said second wavelength impinging on said scanning projection display at said second angle of incidence,
c) a hyperchromatic optical element having a wavelength-dependent focal length,
d) an optical system composed of lens or lenses and/or mirror or mirrors,
whereas said optical system provides images separated in depth and dependent on a viewing angle,
whereas said images are created at different depths such that
an observer perceives a complete three-dimensional image dependent on the viewing angle.

10. The hyperchromatic optical imaging system of claim 9,
wherein said reduced divergence of said scattered light does not exceed ten degrees full width at half maximum in at least one direction perpendicular to the direction of said impinging laser beam.

11. The hyperchromatic optical imaging system of claim 10,
wherein said reduced divergence of said scattered light does not exceed five degrees full width at half maximum in at least one direction perpendicular to the direction of said impinging laser beam.

12. A wavelength-selective focus-correcting optical element comprising
a stack of optical subelements,
whereas said stack of optical subelements is selected from the group comprised of
a) a stack of lenses or curved mirrors,
whereas each element of the stack provides a fixed focal length for a particular selected wavelength range,
whereas maximum variations of said fixed focal length within said particular wavelength range does not exceed ten percent,
whereas said each element does not contribute to focusing of light in the wavelength ranges distinct from said particular selected wavelength range; and
b) a stack of diffraction gratings each covered by a distributed Bragg reflector (DBR),
whereas each element of the stack provides a fixed direction of the diffracted beam for a particular selected wavelength range,
whereas maximum variations of said fixed direction of the diffracted beam does not exceed five degrees,
whereas said each element does not contribute to diffraction of light in the wavelength ranges distinct from said particular selected wavelength range.

13. The hyperchromatic optical imaging system of claim 3, further comprising
d) a wavelength-selective focus-correcting optical element further comprising
a stack of optical subelements,
whereas said stack of optical subelements is selected from the group comprised of:
AA) a stack of lenses or curved mirrors,
whereas each element of the stack provides a fixed focal length for a particular selected wavelength range,
whereas maximum variations of said fixed focal length within said particular wavelength range does not exceed ten percent,
whereas said each element does not contribute to focusing of light in the wavelength ranges distinct from said particular selected wavelength range; and
BB) a stack of diffraction gratings each covered by a distributed Bragg reflector (DBR),
whereas each element of the stack provides a fixed direction of the diffracted beam for a particular selected wavelength range,
whereas maximum variations of said fixed direction of the diffracted beam does not exceed five degrees,
whereas said each element does not contribute to diffraction of light in the wavelength ranges distinct from said particular selected wavelength range
whereas functionalities of hyperchromatism for each wavelength range and said wavelength-selective focus-correcting optical element are combined such that said stack of optical subelements provides the same spread of wavelength-depending foci for all the wavelength ranges.

14. The wavelength-selective focus-correcting optical element of claim 12,
whereas said stack of subelements provides optical transparency of at least 80% in all wavelength ranges, and
whereas said stack of subelements is suitable for direct attachment to a windshield of a vehicle.
